(19) United States
(12) Patent Application Publication
(10) Pub. No.: US 2011/0024233 A1
(43) Pub. Date: Feb. 3, 2011

(54) MAINTENANCE PLATFORM FOR WIND TURBINES

(76) Inventor: Kenneth Skovbo Lott, Sonderborg (DK)

Correspondence Address: Kenneth Skovbo Lott, Midtkobbel 19, Sonderborg, 6400, omitted

(21) Appl. No.: 12/935,598

(22) PCT Filed: Mar. 26, 2009
(86) PCT No.: PCT/EP2009/053589

§ 371 Date: Sep. 30, 2010

Related U.S. Application Data
(60) Provisional application No. 61/041,731, filed on Apr. 2, 2008.

(51) Int. Cl. F03D 11/00; E04G 3/24; E04G 5/00; E04G 3/32

(52) U.S. Cl. 182/129; 182/150; 182/131; 182/143

(57) ABSTRACT

There is provided a suspendable maintenance platform for accessing a blade of a wind turbine. The platform includes arms for holding a maintenance unit, a frame onto which each arm is movably attached in a joint enabling planar movement, and means for supporting the frame in relation to the wind turbine tower. The maintenance unit is slidably attached to the arms that are configured for positioning the platform in relation to the blade, and wherein the frame is configured to be in close proximity to the turbine tower.

### TECHNICAL FIELD

The invention relates to a secure maintenance platform for suspension on cables, in particular for maintaining wind turbine blades.

### BACKGROUND OF THE INVENTION

In many countries wind turbines are deemed by law to be building structures, the engineering design, erection and operation of which are supervised by the building permit offices and by the locally competent building authorities.

The competent authorities require above all that wind turbines, and especially their rotor blades and mechanical engineering components, be monitored at periodic intervals to maintain their operational safety. Irrespective of such requirements, regular maintenance and repair are essential for maximum availability of wind turbines.

In the first years of wind power use, telescopic platforms or so-called aerial platforms, mounted on trucks, were used for inspecting, maintaining and repairing rotor blades.

Owing to the rapid increase in the hub heights of wind turbines, and based on many years of experience in cleaning building facades, intensifying use of wind energy led to modified and hoistable types of suspended access equipment (SAE) being developed. Examples of such suspended access equipment are described in some patent applications (see e.g. WO2007/085265A1, WO2005/064152A2, WO04092577A1, DE10330426A1, DE03228732A1, DE4344210, EP01550779A2, WO04081373A2, and JP09302915). What is common to all these solutions is that inspection, maintenance and repair work is performed on a rotor blade pointing vertically downward. The rotor is successively rotated so that all the blades can be inspected and possibly treated.

The increasing size of wind turbines, not only with respect to hub height, but also to the specific dimensions of the blades, combined with the desire for offshore wind power generation gives rise inevitably to requirements for suspended access equipment that cannot be met or fully met with the construction designs that have existed hitherto. To perform inspection, maintenance and repair work on all the blades of a wind turbine as efficiently as possible, it is necessary to select mountings for the suspended access equipment such that the rotor can still be rotated when the access equipment is suspended. The disadvantage of suspending the access equipment from the rotor blades themselves is that, in order to treat the next rotor blade, the suspended access equipment must be dismounted and remounted again after the rotor has been rotated to the next position. If repair work needs to be carried out in sections where the mounting for the suspended access equipment is located, this type of mounting is unfavorable. Since maintenance and repair work on blades mainly involves lamination and painting work, dismounting and remounting suspended access equipment cannot be carried out until after full hardening, for example of the paint finish, in the area of the mounting.

Current suspended access equipment that is not suspended from the rotor blades themselves, but from the machine house instead have the disadvantage that, although the rotor can still be turned while the suspended access equipment is mounted, it is necessary to release the tension in guy lines to the ground. For offshore applications, such solutions are out of the question, of course.

What is common to all solutions hitherto is that the suspended access equipment lacks the flexibility to adapt to changes in the cross-sectional profile of the workpiece (in this case the blades) during operation.

The bigger rotor blades become, the greater the flange diameters and the greater the maximum blade depth become. The blade tips, etc., and above all their blade thickness, remain approximately the same, in contrast—irrespective of whether the blade is 20 meters or 40 meters in length. The consequence is that the rotor blades can be treated very well in the flange area or in the upper third next to the hub, whereas work becomes increasingly difficult to perform the closer one gets to the blade tip. The reason for this is the increasing gap between the rotor blade or workpiece surface and the closest front handrail of the suspended access equipment, which is limited to a major extent by the distance that personnel can reach.

Within the field of wind turbines it is necessary to perform work on parts that are situated at a considerable height above ground level (or sea level, when sea wind turbines are concerned) such as e.g. repair of rotor blades, the surface of these, surface treatment of rotor blades and the tower etc. Further, it has been recognized that it is advantageous or even necessary to clean such parts and in particular the rotor blades in order to maintain good results as regards the power efficiency.

Further, it may be advantageous to perform other forms of maintenance in order to achieve good power production results and optimal economic results, such as e.g. surface treatments, inspection etc. In order to perform such work a number of hoisting arrangements have been proposed in the prior art.

Such a hoisting arrangement is known from the prior art in which suspension means are fastened to each of the two rotor blades near the hub of the rotor once the windmill has been brought to a stop and with one rotor blade pointing straight downwards. A special work platform with a through-going slit at the bottom has been fixed to these suspension means so that the rotor blade pointing downwards could be inserted into this slit. The work platform has subsequently been hoisted upwards in a stepwise manner, while the crew has rinsed the surface of the rotor blade manually, e.g. with one person located on each side of the rotor blade.

Even with such an arrangement, it is a time-consuming process to carry out a cleaning of the rotor blades of a windmill, just as such a known arrangement would probably require the use of machinery, such as a crane, for fixation of the suspension means. Further, the platform itself will have a considerable weight and size, thereby leading to further costs and use of heavy machinery for lifting and lowering the platform.

Devices of corresponding kind are encumbered with the same disadvantages as those mentioned above, including that extensive use must be made of special material such as cranes, for example mobile cranes, or relatively comprehensive materials which, for example, are mounted on the turbine tower beforehand.

WO 03/048569 A2 describes a method and an apparatus for treatment of a surface of a rotor blade of a windmill, where the apparatus is being placed in such a manner that it is moveable in relation to the surface of a rotor blade, and said apparatus is being caused to move depending on a form of treatment determined by means for treatment mounted on, in or next to the apparatus. In this manner, various forms of treatment of a rotor blade may be carried out such as for instance washing, finishing, sealing etc.

WO 2005/064152 A2 describes a device for enabling access to a structure above ground level by lowering and/or lifting the device in relation to the structure, the device comprising a first endless frame structure defining an opening, wherein at least part of the first endless frame structure forms a track portion, the track portion being adapted to guide an, in relation to the track portion, movable object, such as a gondola, along the track portion.

Both of these prior art documents relate to devices, where the devices are transferred to the rotor blade from below the rotor blade tip.

WO 2004/092577 AI describes a method of servicing the outer components of a wind turbine such as the wind turbine blades and the tower with a work platform, said method comprising the steps of: positioning the work platform at the wind turbine tower and connecting the work platform to an upper part of the wind turbine with at least one cable. Further the method comprises the steps of raising the work platform with the cable and cable winding means to a position of use, and holding the work platform to the side of the wind turbine tower with holding means.

These prior art systems are generally not configured in a manner facilitating user-friendliness and do not provide the personnel with an optimal safety environment.

Thus, it is an objective of the invention to provide an improved device for performing such work at a structure such as a wind turbine, e.g. on a rotor blade or on a wind turbine tower.

It is a further objective to provide such a device whereby improved user-friendliness and safety may be achieved.

A further objective is to provide such a device that allows access to virtually all parts of e.g. a rotor blade with relatively simple and few means.

It is also an objective to provide such a device that may be designed as a relatively light structure and in relatively light materials while maintaining safety standards and even provide improvements in safety aspects.

Finally, it is an objective to provide such a device that may be designed so as to be easily transportable without the need of heavy transportation vehicles.

These and other objectives are achieved by the invention as explained in detail in the following.

### SUMMARY OF THE INVENTION

The aim of the design presented here is to produce a working or maintenance platform suspended on cables, wherein said platform can be used as universally as possible, especially offshore, and is able during operation to provide greatly differing workspaces with ease and without constructional changes.

“Workspace” refers here to the inner cross-section which is enclosed by the working platform and in which the workpieces to be treated are located. The workpieces may be wind turbine rotor blades, in particular, but can also be masts, chimneys, and the like.

The aforesaid aim is achieved according to the invention by a suspendable maintenance platform for accessing a blade of a wind turbine, wherein the platform comprises:
arms for holding a maintenance unit, said arms each being provided with a joint enabling planar movement;
a frame onto which each arm is movably attached in a joint enabling planar movement;
means for supporting the frame in relation to the wind turbine tower;
   wherein the maintenance unit is slidably attached to the arms that are configured for positioning the platform in relation to the blade, and wherein the frame is configured to be in close proximity to the turbine tower.

In a preferred embodiment the maintenance unit is a maintenance platform comprising at least two sub-platforms defining a working plane, wherein said sub-platforms are swivably connected to each other by a swivel joint having a swivel axis substantially perpendicular to the working plane.

Alternatively the maintenance unit is a blade washing unit, a video/scanning unit or the like.

In a particularly preferred embodiment the present invention provides a suspendable maintenance platform for accessing a blade of a wind turbine, wherein the platform comprises:
at least two sub-platforms defining a working plane, wherein said sub-platforms are swivably connected to each other by a swivel joint having a swivel axis substantially perpendicular to the working plane;
arms for holding the sub platforms;
a frame onto which the arms are movably attached;
means for supporting the frame in relation to the wind turbine tower;
   wherein the sub-platforms are slidably attached to the arms that are configured for positioning the platform in relation to the blade.

A maintenance platform of this kind removes the inability of previously existing suspended access equipment to adapt flexibly to different work pieces whose perpendicular cross-sectional projection changes considerably over the path traveled by the platform. As a result, the personnel is able to perform work simultaneously at any time on different parts of the work piece.

In one preferred variant of the invention, the maintenance platform has five sub-platforms connected to each other by swivel joints. This configuration leads to the maintenance platform almost fully enclosing the workspace, thus enabling access from all sides to a rotor blade to be maintained. The enclosed configuration also increases the stability of the maintenance platform, of course. By inserting intermediate segments in each single platform before work begins, it is also easy to move up and down rotor blades. In one advantageous variant of the invention, the sub-platforms are configured so that they can be enlarged by inserting intermediate segments.

In order to adjust the sub-platforms, a drive is preferably provided for each degree of freedom, said drive connecting sub-platforms in such a way, for example, that the sub-platforms can be swiveled in the working plane relative to each other with the aid of the drive. The drive provided for swiveling the sub-platforms is preferably a spindle drive that connects the sub-platforms with each other and is disposed relative to the swivel joint connecting said sub-platforms in such a way that the sub-platforms can be swiveled in the working plane relative to each other with the aid of the spindle drive. Alternatively, the drive can also be disposed in the swivel joints themselves. Overall, a maintenance platform with at five sub-platforms and at four swivel joints connecting said sub-platforms enables a five-bar linkage to be realized that permits variable inner contours to be achieved and thus enabling the maintenance platform to be easily adjusted during operation to different cross-sectional profiles.

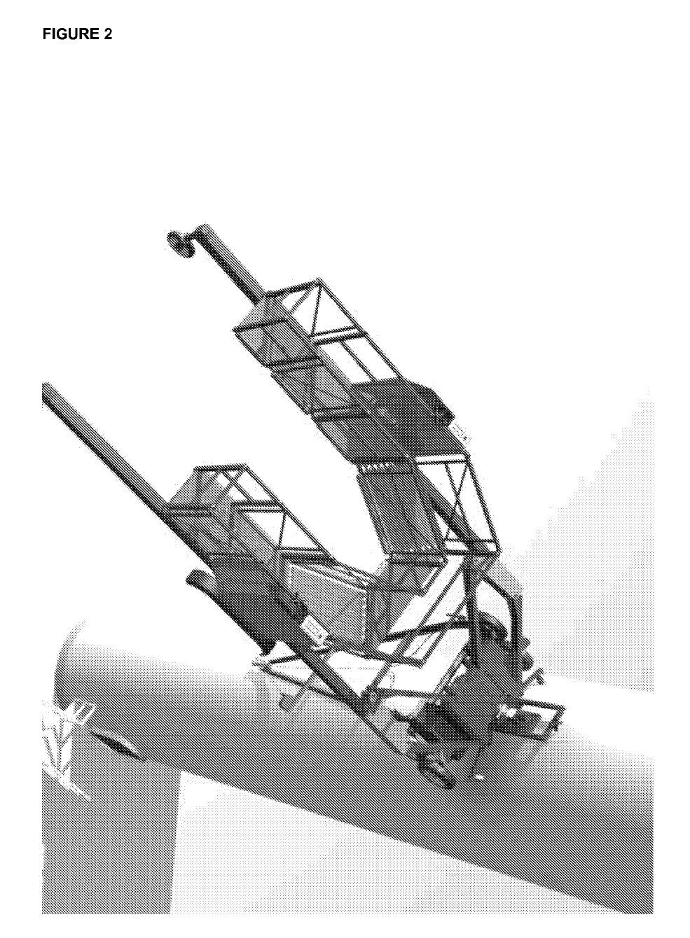

Further adjustment is achieved by moving/sliding the sub-platforms (and thus the entire platform) along the arms of the frame. As mentioned above the arms are movably attached to the frame of the platform; this attachment is e.g. achieved though another set of arms and accompanying joints so as to form a set of hinges (see FIG. 2). The arms may be configured so that they can only move parallel to each other. One very important effect of the arms is that when the blade enclosed by the platform moves in the wind the platform is follows this movement.

The maintenance platform preferably has three cable winches as well, with which the maintenance platform can be displaceably attached to three support cables. The cable winches are provided with motors for driving the cable winches in such a way that the resultant speed of movement of all three cable winches is identical when the cable winches are turning. Preferably, therefore, the cable winches all have an identical drum diameter and are driven by electric motors operating with a uniform speed.

The maintenance platform is preferably part of a maintenance system in which the maintenance platform is preferably suspended via the aforementioned cable winches on three support cables, of which at least one is suspended from a cable suspension member on one side of a rotor plane of a wind turbine facing away from the tower. The expression “facing away from the tower” refers here to the plane described by the rotor blades and in which the rotor blades rotate, and to the wind turbine tower, at the top end of which the rotor blades are usually rotatably mounted to a nacelle which can be swiveled in a horizontal plane such that the plane of the rotor blades is substantially vertical and parallel to the tower. All the support and safety cables are configured in such a way that none of the cables intersect the rotor plane.

With the solution presented here, it is possible to turn the rotor while the suspended access equipment is mounted. The support and safety cables are not fastened simultaneously to the ground. The construction presented is therefore equally suitable for onshore and offshore use.

The cable suspension member preferably has a three-point mounting of adjustable diameter for mounting the cable suspension member on a rotor hub.

In addition, the cable suspension member preferably has a cable mount to which at least one of the support cables must be attached. In relation to the rest of the cable suspension member, the cable mount is preferably freely rotatable, specifically about a rotational axis that is identical to the rotational axis of the rotor blades. Said rotational axis of the cable mount preferably runs through the center of a triangle of attachment points defined by the three-point mounting. The rotational axis is perpendicular to the plane defined by the three attachment points.

The present construction is also rendered suitable for use by virtue of suspension from at least two points, of which at least one is attached to the hub in front of the rotor plane by means of the cable suspension member. The cable suspension member rotates with the rotor, without the support and safety cable rotating as well. This prevents the cables from twisting.

### PREFERRED EMBODIMENTS OF THE INVENTION

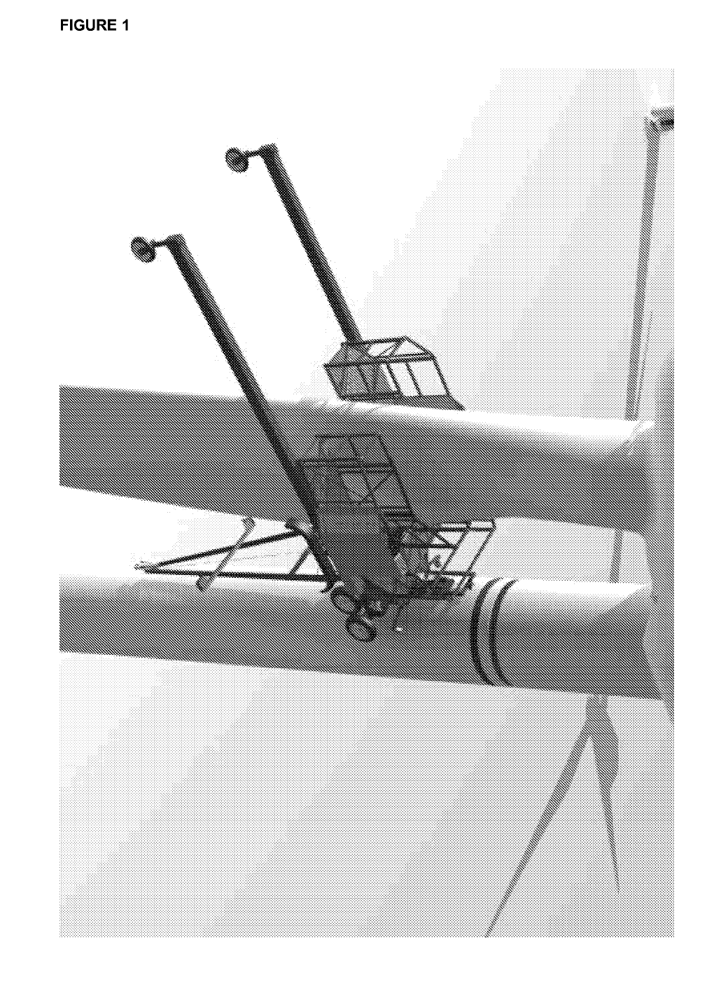

The wind turbine shown in FIG. 1 comprises a tower, a horizontally swivelable nacelle mounted on the top end of tower and a rotor which is rotatable about a horizontal axis and mounted inside the nacelle. Rotor comprises three rotor blades attached to a common hub.

A maintenance platform of the present invention is suspended from nacelle and hub by means of support cables (not shown). One of said support cables is attached to the hub by means of a cable suspension member, while additional support cables are attached to nacelle. The maintenance platform, support cables and cable suspension member together form a maintenance system.

FIG. 2 provides a separate view of the maintenance platform. The maintenance platform is comprised of 5 sub-platforms swivably connected to each other by four joints to form a horse shoe shaped four-bar linkage.

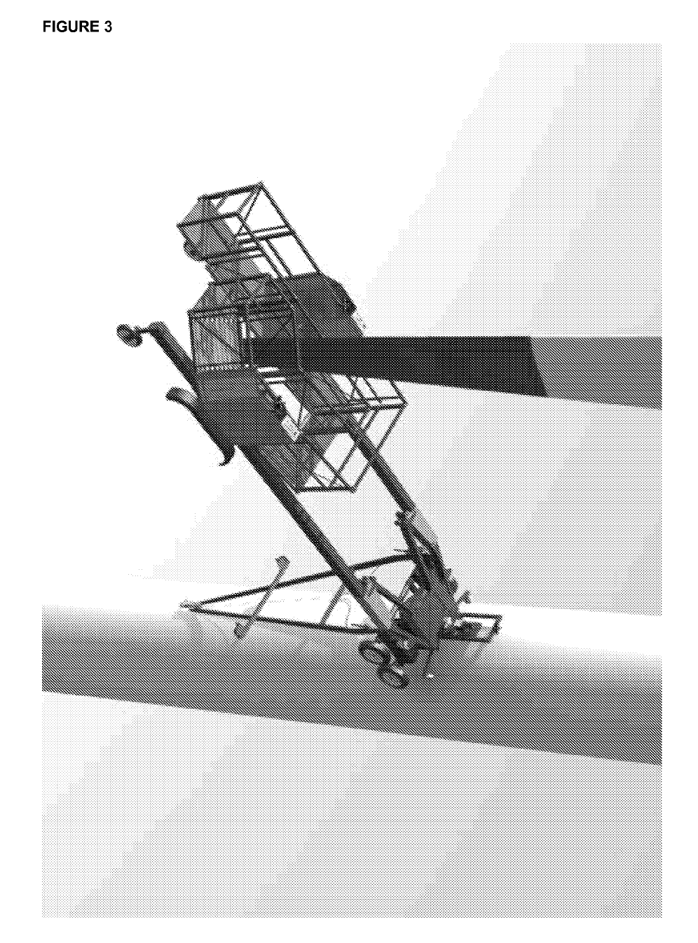

One characteristic of the maintenance platform is that the workspace enclosed by maintenance platform can be modified by swiveling the four sub-platforms relative to each other. Another important characteristic of the maintenance platform is that is slidable along two arms. It is possible in this way to adapt the workspace enclosed by the four sub-platforms optimally to the contours of a rotor blade requiring maintenance. FIG. 3 shows how these characteristics enable the platform to reach rotor parts remote from the tower of the wind turbine.

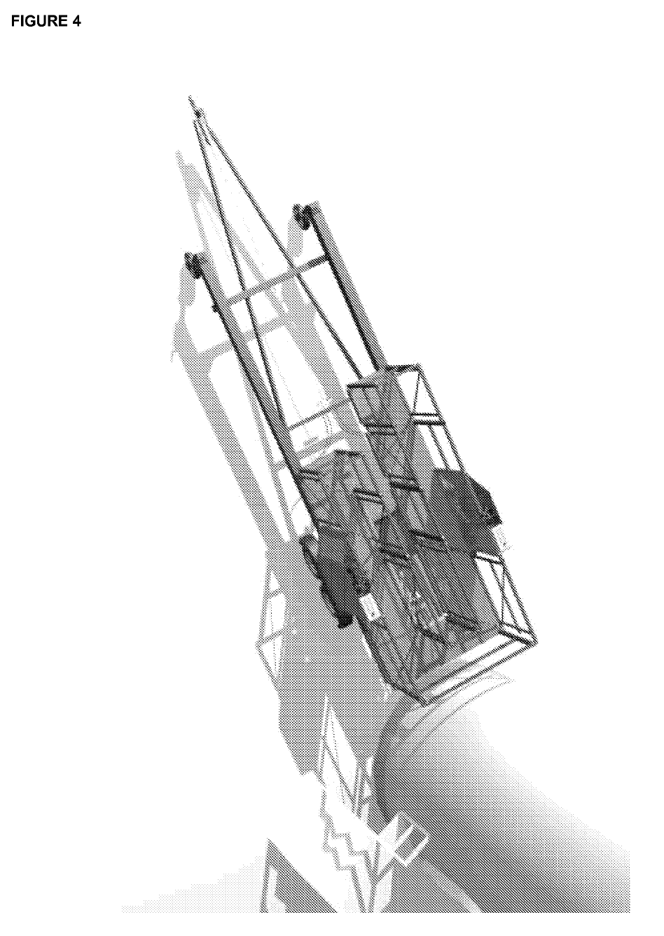

As can be derived from FIG. 1-3, and in particular FIG. 4, the maintenance platform is slidably attached to two arms, which arms can be moved parallel to each other, said arms being mounted with hinges on the frame. As can also be derived from the figures the frame may be a frame of a car trailer enabling transportation of the platform with a personal car. In this case the trailer arm (triangular arm to be mounted on the car) constitutes an extra support means for the complete platform, since it stabilizes the platform when contacting the tower of the wind turbine; in order to ensure stable contact between the tower and the triangular arm is provided with electromagnets that can releaseably attach the arm onto the tower.

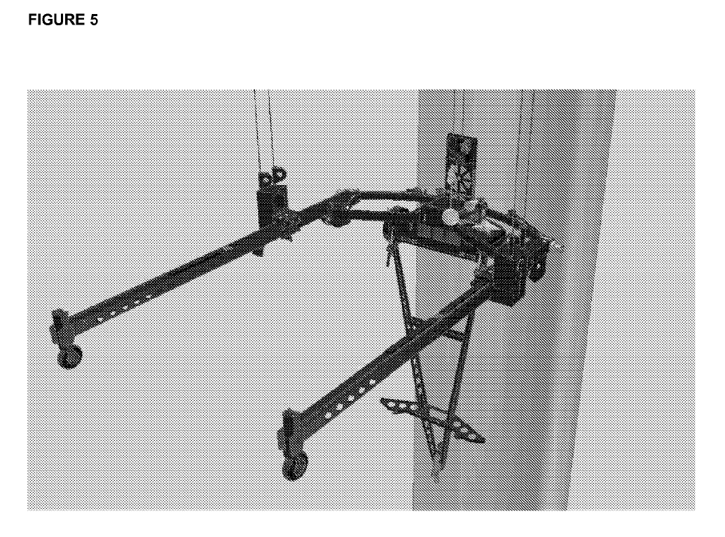

As illustrated in FIG. 5 the maintenance platform may be removed for possible replacement with another maintenance unit.

Finally, the present invention also provides a system for attaching the wires of a maintenance platform to a nacelle of a wind turbine. The system comprises a frame for holding one or more winches for receiving one or more robes; the robes are released from the nacelle and should be lowered to the ground level for being attached to the winches. By activating the winches the system is elevated towards the nacelle, and since the system is connected to the wires (to be used for the maintenance platform of the present invention) they will follow the system towards the nacelle. When the system reaches the nacelle it is securely attached to the nacelle, whereby the wires are safely connected to the nacelle.

1. A suspendable maintenance platform for accessing a blade of a wind turbine, wherein the platform comprises:
arms for holding a maintenance unit, said arms each being provided with a joint enabling planar movement;
a frame onto which each arm is movably attached in a joint enabling planar movement;
means for supporting the frame in relation to the wind turbine tower;
wherein the maintenance unit is slidably attached to the arms that are configured for positioning the platform in relation to the blade, and wherein the frame is configured to be in close proximity to the turbine tower.

2. The suspendable maintenance platform according to claim 1, wherein the maintenance unit is a maintenance platform comprising at least two sub-platforms defining a working plane, wherein said sub-platforms are swivably connected to each other by a swivel joint having a swivel axis substantially perpendicular to the working plane.

3. The suspendable maintenance platform according to claim 1 further comprising a spindle drive adjustably connecting two of the sub-platforms, said spindle drive being disposed in such a way relative to the swivel joint likewise connecting the two sub-platforms that both sub-platforms as well as the other sub-platforms can be swiveled relative to each other in the working plane with the aid of said spindle drive.

4. The suspendable maintenance platform according to claim 1 further comprising three cable winches for displaceably attaching the maintenance platform to three support cables.

5. The suspendable maintenance platform according to claim 4, wherein the cable winches are each provided with an electric motor, said electric motors being configured to maintain a uniform speed of movement.

6. The suspendable maintenance platform according to claim 1, wherein the frame is the frame of a car trailer enabling transportation of the platform with a personal car.

7. A system for attaching the wires of a maintenance platform to a nacelle of a wind turbine comprising a frame for holding one or more winches for receiving one or more robes, attachment means for the wires, and means for attaching the system onto the nacelle.
